(19) United States
(12) Patent Application Publication
(10) Pub. No.: US 2009/0318256 A1
(43) Pub. Date: Dec. 24, 2009

(54) Force Amplification Method and Apparatus by the Harnessing of Centrifugal Force

(76) Inventor: Geoffrey William Good Leviny, New South Wales (AU)

Correspondence Address: SHOEMAKER AND MATTARE, LTD, 10 POST OFFICE ROAD - SUITE 100, SILVER SPRING, MD, 20910, US

(21) Appl. No.: 12/442,832

(22) PCT Filed: Oct. 1, 2007
(86) PCT No.: PCT/AU2007/001434

§ 371 Date: Mar. 25, 2009

(30) Foreign Application Priority Data
Sep. 29, 2006 (AU) 2006905381

(51) Int. Cl. F16H 33/02; F03G 7/10

(52) U.S. Cl. 475/267; 74/DIG. 9

(57) ABSTRACT

A force or energy amplifying apparatus (10) including a pair of frame gears (24), the gears (24) being mounted rotatably on radial arms (16, 17) for rotation about an output shaft (14), an input sprocket (38) for coupling to an input to cause rotation of the radial arms (16, 17) and orbital movement of the gears (24) about the output shaft (14), the gears (23) carrying weight gears (31) which upon orbiting movement of the gears (24) cause rotation of the gears (24) and an output gear (20) on the output shaft (14) coupled to the gears (24) to extract energy therefrom. Part of the energy from the output shaft (14) is returned to the input to maintain operation of the apparatus (10).

### TECHNICAL FIELD

This invention relates to a force or energy amplification method and apparatus and in particular to a force or energy amplification method and apparatus which uses centrifugal force for converting an input force into an output force. In a particular but not exclusive aspect, the present invention relates to a method and apparatus for transferring centrifugal force into a cranking force to apply energy to a shaft when the center of gravity/mass within a gear or other rotational body is manipulated to rotate continuously off center to one side around the center of another gear or axis.

### BACKGROUND ART

A number of attempts have been made to harness and utilize centrifugal force as a useful energy source. Examples of apparatus using this principle are disclosed in JP57137741A2, JP08256470A2, US20040234396A1, JP10153163A2 and JP10026074A2. As far as the applicant is aware none of the apparatus disclosed in the above documents have been successfully implemented.

### SUMMARY OF THE INVENTION

The present invention provides in one particular aspect, a force or energy amplifying apparatus comprising:

at least one gear assembly having an axis of rotation, said gear assembly being mounted for orbital movement around an orbit axis,

means for causing said gear assembly to orbit around said orbit axis in response to a rotational input;

means for causing rotation of said frame gear assembly about its axis of rotation during said orbital movement of said frame gear assembly as a consequence of centrifugal force;

and means for extracting energy from said orbiting and rotating gear assembly.

Preferably part of the energy extracted from the orbiting and rotating gear assembly is returned to provide the rotational input.

In another preferred aspect, the present invention provides a force or energy amplifying apparatus comprising:

an input shaft;

an output shaft defining an orbit axis;

an output gear fixed for rotation with said output shaft;

at least one frame gear assembly having an axis of rotation, said frame gear assembly being mounted for orbital movement around said output gear in response to an input from said input shaft;

means for positioning and maintaining the effective center of mass of said frame gear assembly at a position or positions off-center relative to the center of said frame gear whereby to cause rotation of said frame gear assembly about its axis of rotation during said orbital movement of said frame gear assembly;

and means coupling said frame gear to said output gear whereby motion of said frame gear can be transmitted to said output shaft

Suitably means are provided for returning part of the output from the output shaft to drive the input shaft to maintain operation of the apparatus. The returning means may comprise mechanical or hydraulic transmission means.

Preferably the apparatus comprises at least one pair of frame gears assemblies, respective frame gear assemblies of said the being arranged symmetrically on opposite radial sides of the output gear.

Suitably a frame gear shaft for each frame gear assemblies is mounted at a position spaced radially from and extending parallel to the output shaft so that the frame gear assemblies orbit at a constant radius from the orbit axis. The frame gear assemblies are suitably supported to the frame gear shaft for free rotation there around.

Each frame gear assembly suitably comprises a frame gear and mass adjusting means carried by the frame gear for adjusting the center of mass of the frame gear assembly.

In one form the mass adjusting means comprise weight gears, said weight gears being movably mounted on the frame gear to enable adjustment of the effective center of mass of the frame gear assembly.

Preferably the weight gears comprise a pair of weight gears arranged symmetrically on opposite radial sides of the axis of rotation of the frame gear. Each weight gear is suitably supported on the frame gear for rotation about an axis extending parallel to the axis of the rotation of the frame gear. The weight gears may be supported for rotation on pedestal shafts mounted on one side of the frame gear. Preferably the center of mass of each weight gear is offset relative to its axis of rotation. Each weight gear suitably carries a weight offset from its axis of rotation. Preferably the weight gears are in mesh with a common drive gear coaxial with the frame gear through which rotation can be transmitted to the weight gears. The weight gears are arranged such that each weight or center of mass of each weight gear is concurrently radially outermost. Suitably the weight gears on opposite sides of the output shaft are arranged symmetrically relative to each other.

Preferably a drive gear is mounted to the frame gear shaft for rotation therewith. Preferably the frame gear shafts are supported by spaced radial arms mounted for rotation relative to the output shaft, the radial arms extending symmetrically on opposite radial sides of the output shaft. Preferably the frame gear shafts are adapted to receive an input from an external source to drive the drive gears, the input force of the input being amplified in use by the apparatus of the invention.

Preferably the frame gears are coupled to the output gear through idler gears. The idler gears are suitably rotatable mounted on the radial arms.

The rotation of the center of gravity or mass around the center of a gear as achieved by the pair of weigh gears mounted to a frame gear could be achieved by any means such as rotating weights as employed and described above or variations including any means of weight transfer such as sliding weights whether operated by a cam or solenoid or hydraulics.

In another form, hydraulic fluid may be used to adjust the center of gravity or mass of the frame gear assemblies.

Whilst the invention is most suitably used in relation to rotatable and orbiting gears, it may also be applied to other rotatable bodies.

Thus the present invention in another aspect provides a self-powered force or energy generating apparatus, said apparatus comprising at least one body rotatable about an axis of rotation, said body being mounted for orbital movement around an orbit axis, means for causing said body to orbit around said orbit axis in response to a rotational input, means for causing rotation of said body about its axis of rotation during said orbital movement of said body as a consequence of centrifugal force, means for obtaining a force or energy output from said orbiting and rotating body and means for returning part of said output to said input to maintain operation of said apparatus.

In yet a further aspect, the present invention provides in a broad aspect, a method of amplifying force or energy applied from an input, said method including the steps of causing a rotational body having an axis of rotation to orbit at a constant radius about an orbit axis in response to said input force or energy, weighting said body such that when orbiting, said body rotates under the influence of centrifugal force about its axis of rotation, and extracting energy from said orbiting and rotating body.

Preferably the method further comprises the step of applying part of the extracted energy to the input to maintain the orbiting and rotational movement of the rotational body. The body suitably is weighted variably to maintain its rotation during the orbital movement thereof.

Given that the properties of mass exhibited by a body spinning around a fixed point expresses angular momentum and centrifugal force, the function of the apparatus is to spin or rotate a body so as to maintain the angular momentum and convert centrifugal force into a cranking force to generate energy. All these features are known to science and as with solar energy are unlimited.

An input power source is required to start up the system. When running, some energy is required to be returned to the input to maintain the operation upstream of the output, and to compensate for frictional losses.

It is believed that by way of explanation of centrifugal force, but not dependent on this explanation that it is probable that atoms express electro magnetic energy which requires a balance of distribution of their positive and negative components so that the electrons need to be in synchronized rotation so as to maintain that balance of distribution between adjoining atoms. When a body is rotated the atoms contained therein add rotations and so change the orientation of the electrons in relation to those about and so are repelled outwards. This is centrifugal force, a pseudo force of gravity. This force is directly proportional to the number of atoms in the rotated body (the mass of the body), proportional to the radius of the rotation and proportional to the square of the revolution rate.

The apparatus functions because; in a simple one to one gearing model, the transfer of input force, for every one unit of input energy two units are delivered to the output.

The method of achieving this is explained in the following:

If the input drive, acting through the final chain drive were applied to a solid rigid frame gear mass, the chain would act as a solid, and transfer the energy of the input, to the rotational effort of the frame gear mass around the output gear, and deliver it as usable energy at the output gear, equal (less friction) to the input.

In the apparatus according to the invention, the frame gear is not a solid rigid mass, but it will behave as such due to the centrifugal hold on the weights making it act as a solid. Since this centrifugal hold is not absolute, in resistance to the input against the weight gears, the weight will rotate away from the line of centrifugal force, and having done this, the effective center of gravity (mass) of the frame gear is then to the side of the frame gear. With centrifugal force now acting to that side of the frame gear, the frame gear will rotate, which it then delivers to the output gear as a second force. Calculations of this second force show that it is the same as the input. Thus output equals twice the input.

Since output forces are the result of the rotation of the weight gears, (provided gearing is one to one) both forces are delivered simultaneously, and regardless of mix of contribution, output rpm will be the same as input rpm, all be it at twice the energy.

While the system is in operation with a given input force, any resistance or take off at the output, will cause the same sequences of forces as would additional input, because in both cases, the input force will be expressed as greater resistance at the first point of contact with the frame gear, this being the weight gear. The effect will be to rotate the weights further away from the line of centrifugal force.

This will increase both output forces, while using only the input force of one, to increase the rotational effort of the frame gear mass around the output gear, and so add rotation to the output gear and increase leverage to rotate the frame gear, and so add rotation to the output gear.

The apparatus of the present invention has a number of applications including as stand alone power plants as single units or multiple units in any configuration including stacked on top of one another, side by side including on common axle shafts, for any mechanical energy application including water pumping and treatment, the generation of electricity, powering of vehicles, marine vessels, air craft, or any other mechanical devise including use in space or anywhere. The machine of the invention may be made to any size to suit any requirement for on site and portable, to regional supply of energy. Regional power generation would eliminate the need and costs associated with long distance transportation of energy be it electricity, fossil fuel or whatever.

### BRIEF DESCRIPTION OF THE DRAWINGS

In order that the invention may be more readily understood and put into practical effect, reference will now be made to the accompanying drawings which illustrate a preferred embodiment of the invention and wherein:

FIG. 1 is plan view of apparatus according to an embodiment of the invention;

FIG. 2 is a sectional side view of the apparatus along line A-A of FIG. 1;

FIG. 3 is a sectional plan view of the apparatus along line B-B of FIG. 2;

FIG. 4 illustrates a practical embodiment of apparatus according to the invention; and

FIGS. 5 to 15 are charted test results carried out on the apparatus of FIG. 4.

### DETAILED DESCRIPTION OF THE PREFERRED EMBODIMENT

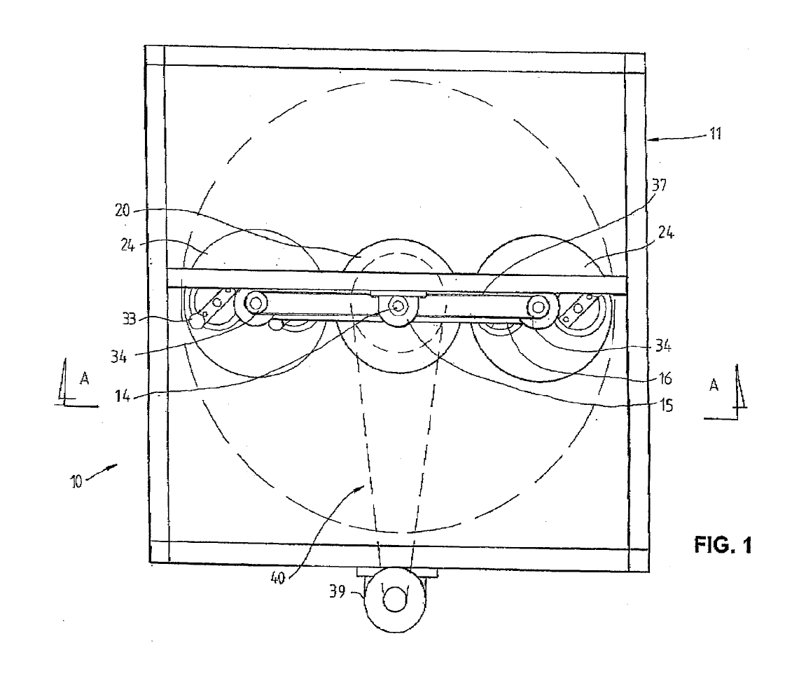

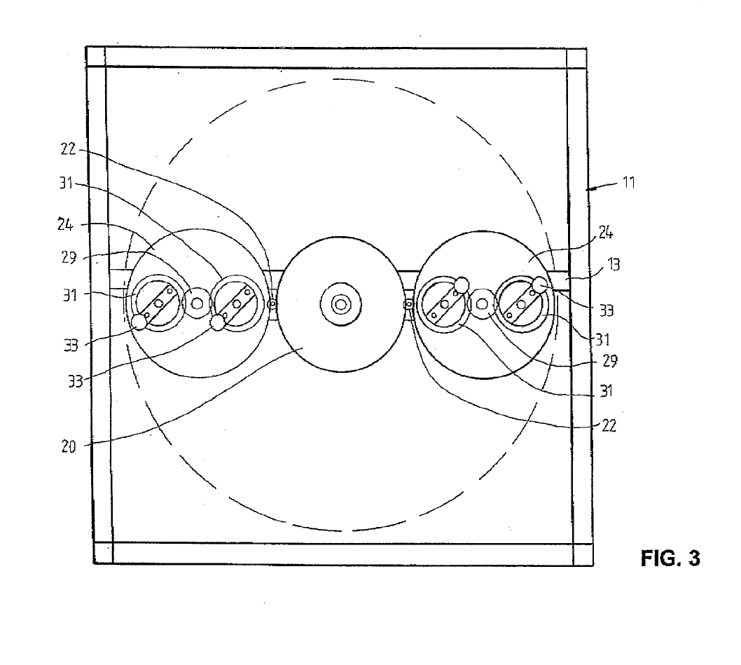

Referring to the drawings and firstly to FIGS. 1 to 3, there is illustrated energy conversion apparatus 10 according to the present invention for converting centrifugal force into usable energy, the machine 10 including a rectangular box like perimeter frame 11 having upper and lower parallel cross arms 12 and 13 arranged centrally of the frame 11. The apparatus 10 includes an output shaft 14 supported rotatably in bearings 15 to the upper and lower cross arms 12 and 13.

Upper and lower radial arms 16 and 17 are mounted to the shaft 14 through bearings 18 and 19, the arms 16 and 17 extending diametrically and symmetrically of the shaft 14 and therefore extending radially the same distance on opposite sides of the shaft 14.

Positioned between the upper and lower arms 16 and 17 is an output gear 20 which is fixed for rotation with the shaft 14.

A pair of pedestal shafts 21 are mounted on the lower radial arm 17 to project parallel to the output shaft 14 therefrom at an equal spacing from the output shaft 14 and positioned radially in substantial alignment with the outer edge of the output gear 20. Each pedestal shaft 21 carries a reverse idler gear 22 each of which is in mesh with the output gear 20.

Respective frame gear assemblies 23 are provided at opposite ends of the arm 17, the frame gear assemblies include frame gears 24 which are in mesh with the reverse idler gears 22, the frame gears 24 being mounted via bearings 25 to frame gear shafts 26, the frame gear shafts 26 being mounted to the upper and lower arms 16 and 17 by respective upper and lower bearings 27 and 28

The frame gear shafts 26 also carry drive gears 29 which are fixed for rotation with the frame gear shafts 26, the drive gears 29 being positioned above the frame gears 24.

Each frame gear assembly 23 additionally includes on its frame gear 24, a pair of pedestal shafts 30 arranged symmetrically and diametrically on opposite sides of the shaft 26. The frame gear assemblies 23 also include weight gears 31 which are mounted via bearings 32 to the respective pedestal shafts 30, the weight gears 31 being in mesh with the drive gear 29. Each weight gear 31 is weighted on one side such as by means of an attached weight 33 or by having a weight built into the gear 31 or by having the gear 31 manufactured with an offset weighting. The center of mass of the weight gears is thus radially offset from their axis of rotation. The weight gears 31 are arranged such that when one weighted side of a weight gear 31 is directed radially outwardly from the output shaft 14, all weighted sides of all weight gears 31 on opposite sides of the apparatus 10 are directed radially outwardly from the output shaft 14, The weighted sides of the weight gears 31 on one side of the shaft 14 however are arranged diametrically opposite the weighted sides of the weight gears 31 on the diametrically opposite side of the shaft 14.

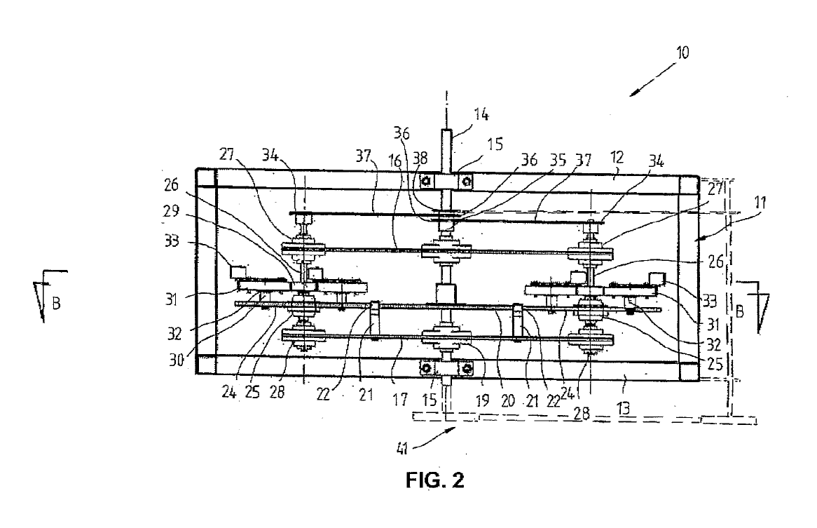

As shown in FIG. 2, the frame gear shafts 25 project at one end beyond the arm 16 and carry respective final chain sprockets 34. The output shaft 14 carries a freely rotatable collar 35 which carries respective input sprockets 36 and respective endless drive chains 37 couple the final chain sprockets 34 to the input sprockets 36.

The freely rotatable collar 35 carrying the sprockets 36 is adapted to be driven by an input drive sprocket 38 fixed for rotation with the collar 35. The input drive sprocket 37 may typically be driven by any input such as by a drive motor 39 mounted to the frame 11 and coupled via a belt/pulley transmission (or sprocket/chain transmission) 40 to the sprocket 38 (see FIG. 1). A belt/pulley chain/sprocket transmission 41 shown in dotted outline in FIG. 2 is provided to return output from the output shaft 14 to the input drive sprocket 38. Alternatively the transmission may comprise a hydraulic or hydrostatic transmission. As an alternative to the sprockets and chains, belts and pulleys may be used for transmission of rotary motion between the respective components of the apparatus 10.

In use, the drive motor 39 is operated to apply a drive to the input sprocket 38 to start the operation of the apparatus 10 at a required revolution rate and thereafter a return from the output at the output shaft 14 can be applied to maintain this and compensate for energy losses including the non recoverable losses of friction within the machine 10.

When a clockwise drive is initially applied by the motor 39 to the input sprocket 38, drive is conveyed via the drive chain 37 and final drive sprockets 34 to the frame gear shaft 26 and thus to the drive gears 25.

At lower speeds, rotation of the drive gears 25 will cause rotation of the meshing weight gears 31 on their pedestal shafts 32 and thus cause rotation of the frame gears 24 about the frame gear shafts 26. The meshing of the frame gears 24 with the idler gears 22 which are in mesh with the output gear 20 will cause orbiting movement of the frame gear shaft 26 and the frame gears 24 thereon and rotational movement of the radial arms 16 and 17 in a clockwise direction around the output shaft 14. As the speed of rotation of the frame gears 24 increases, the centrifugal force exerted by the weights 33 of the weight gears 32 will effectively lock the frame gears 24 against rotation relative to their shafts 26. The chains 37 will now act as rigid arms between the input drive sprocket 38 and the final chain sprocket 34 and rotate around the output shaft 14 with the arms 16 and 17 at a rotational velocity equal to the input velocity applied by the motor 39. As the frame gears 24 are now locked against rotation but continue to orbit around the output shaft 14, their meshing with the idler gears 22 will causes rotation of the output gear 20 in a clockwise direction, this being a flywheel effect with stored maintenance energy due to the weighted frame gear assembly 23 being positioned at a radius from the output shaft 14. This comprises the first of two driving forces applied to the output gear 20 and thus to the output shaft 14. In addition a centrifugal force is generated in the frame gears 24 due to their rotation about the shaft 25.

The rotational driving of the frame gear shafts 14 from the drive motor 39 also continues to drive the drive gears 29 which results in an anticlockwise rotation of the weight gears 31 which causes the weights 33 carried by the weight gears 31 to rotate anticlockwise within the frame gears 24. Due to resistance to spin by the frame gears 24 an amount of overspin or advance of the weights 33 past the most outward line from the output shaft 14 will occur. Resistance is due to force required to maintain the angular momentum of the frame gear components, friction and any retarding effort on the output shaft 14 from the drawing off of energy for external use and/or returning as the maintenance drive to the input drive sprocket 28.

As the weighted side of the weight gears 30 rotate, the centrifugal force acting on them will cause the rotation of the frame gears 24 to synchronize and match the rotation of the weight gears 31. When the weight gears 31 are rotated to carry the weights 33 anticlockwise, the effective center of mass of the frame gear assembly 23 which is governed primarily by the position of the weights 33 will be located anticlockwise relevant to a radial line extending from the output shaft through the axis of rotation of the frame gears 24 irrespective of the rotational speed of the frame gears 24. The position of the center of mass however will vary due to friction or load drawn from the output shaft 14.

With the weights 33 in advance, the effective center of gravity or mass of the frame gears 34 moves anticlockwise, such that the centrifugal force acting through the effective center of gravity or mass of the frame gears 24 which are not in line with, but advanced ahead of the radial arms 16 and 17 will cause the frame gears 24 to rotate clockwise due to an applied torque movement about the frame gear shafts 25. The clockwise rotation of the frame gears 24 is transmitted through the idler gears 22 to the output gear 20 and comprises a second driving force applied to rotate the output gear 20 clockwise.

Since the revolution rates of both forces are tied to the revolution rate of the weight Rears 31, the second force can add to the first “flywheel” force without altering the output RPM, provided that the gearing is matched, thus compounding the output force by the strength of the second force at any given frame gear revolution rate induced by centrifugal force on the weight gears 31, since the output force is not directly proportional to the input force (although governed by it) but rather to the centrifugal force which accords to the formula F=WRn2/2933

where F=centrifugal force in pounds

W=weight of added weights to drive gear in pounds

R=Radius as per length of radius arms in feet

n=Revolutions per minute of drive gears

The gearing of the apparatus can be considered at two levels, the first level being the input gearing which includes the start up and/or maintenance source to the input as referred to above. It also includes the gearing of this to the input drive sprocket 38. The first gearing level should maintain a set ratio of input to output and this can be varied to suit a particular application although allowance may be necessary when returning power to the input through the return transmission 41.

The second level of gearing is the output gearing between the input drive sprocket 38 and the output shaft 14 which has two trains or linkages as referred to above. Within the second level of gearing, the first force can be considered as a one to one gear ratio as no spinning or rotation need occur between the components for the transmission of that force, the frame gear 24 being locked against rotation.

While the gearing of the second force must be calculated as the gearing to the weight gear 31, (being considered as though it was a gearing to the frame gears 24, this is because under operating revolutions, centrifugal force makes the frame gears 24 rotate as one with the weight gears 29) plus the gearing from the frame gears 24 to the output shaft 14 via the idler gears 22 and output gear 20.

Whilst the rotation of the output gear 20 is shown in the drawings to be conveyed via the output shaft 14 to return energy to drive the input drive sprocket 38 by direct drive, a variable mechanical drive, or any other means such as hydraulic or electric drive systems may be used to drive the input sprocket 38 from the output shaft 14 so as to maintain the operation of the apparatus 10.

All gearing must be configured to suit the method of maintaining the input power when diverting any of the output to the input. If returning power is by direct invariable mechanical linkage, the gearing of the second force must be at a one to one gear ratio, since a given output rpm is produced from a given input, two different input revolution rates can not simultaneously occur. This means that if an invariable output rpm is to be returned to the input, it must be at the reverse ratio of the input to output production.

Given that any increase in revolution rate of the radial arms produces a four-fold increase in centrifugal force applying to the weights, it follows that the second force applied by the apparatus 10 will accordingly increase its contribution to the rotation rate of the output gear 20. Further at any given input rpm, the more the final, chain sprocket 38 rotates (in contrast to non spin that applies the first force rotation of the frame gears) in response to resistance to the input torque so as to drive the weights to advance can alter the contribution of the second force in its substitution for the first force. This substitution must be on a one for one gearing ratio or it will cause a varying in input to output ratio that will trigger internal tensions that drain energy or even cause breakage, if return of power is not controlled as by variable systems.

While the principles of generation of the second force apply to any different configurations of apparatus, a different balance of contributions from the first and second output forces may result, since any variation in the balance in total frame gear mass and the mass of the weights will change the dynamics of each, because the energy to supply to or extract from both flywheel and centrifugal forces varies with mass, radius and gearing.

The input force at any given time is expressed against the weight gears and applied at the tangent of the weights arc. This can be calculated from the angle forming the vector of the line of the centrifugal line and the tangent line from the weights, and this multiplied by the centrifugal force applying to it (in accordance with WRn2/2933 as referred to above).

In these conditions the power from the input is expressed at the output in two ways. Firstly, with the exception of frictional forces, all the input power (as explained above) is applied to rotate the frame gears 24 with the same segment of the frame gears 24 always closest to the output gear 20. This effective lock to the frame gear 24 will apply torque to the output gear 20 in the form of kinetic, or flywheel energy. This force therefore matches the input force and is as calculated as above for the input.

Secondly, power at the output is also derived from the torque applied to the frame gears 24 by centrifugal force (being a by-product of angular momentum) applying to each of the weights 33 (as advanced from their radial line) and this is conveyed through the idler gears 32 to the output gear 20. This second force is delivered at a range of force in consequence to the range of moments caused by the amount of advance of the weights 33 from their line of centrifugal force. This can be measured since the centrifugal force of the weights 33 is expressed at all points along the centrifugal line. By multiplying the centrifugal force (WRn2/2933) by the length of a line from the point adjacent to the center of the frame gear 24 to the center of the frame gear 24, then dividing this by the radius of the frame gear 24 gives the moments of torque applied to the idler gear 22 and from the idler gear 22 to the output gear 20.

Since the second force is a consequential force resultant from the advance of the weights incumbent in the balance of the first forces, all this output less frictional loss is gain, and so can be used to power external applications.

While it is the second force that uses centrifugal force to achieve the additional output, for this to happen, the angular momentum of the first force must be maintained. This is best achieved by arranging the common gearing of the two forces, such that the final drive gear 29 has a step up gearing to the weight gear 31 with this compensated by a step down from the frame gear 24 to the output gear 20 so as to maintain the one to one gearing between the two forces.

With this configuration comparatively more resistance to the input will be met by the second force when being conveyed from the frame gear 24 to the output, while not affecting the force required for angular velocity in the first force. Resultant from this, the essential angular velocity of the first force will not be reduced when output energy is drained off.

If centrifugal force is not strong enough to restrain the weight gears exceeding an advance of 900 to their line of centrifugal force (due to the apparatus not being run fast enough or more power being drained off from the output than is surplus) the torque supplied by the weights will diminish to the 1800 point and thereafter act in reverse, causing the output gear 20 to decelerate, with the maximum deceleration occurring at 2700 when the decrease in rpm of the frame gear 24 will be a negative rpm of 100% of the relative rpm of the weight gears 31. This will cancel the input force of the first force.

In testing of the practical embodiment of the apparatus shown in FIG. 4 and under constant slowly run electric motor input, the weights 33 can be seen to advance 450 on their arc when hand pressure resistance is applied to the output shaft 14 and when removed the weights return to full extension of the radius.

Using a photo tachometer D-2236 to measure the rpm of various components, with a digital camera recording the reading on movie mode, and these readings transcribed to a spreadsheet and converted to a chart, conformation of the two forces have been shown.

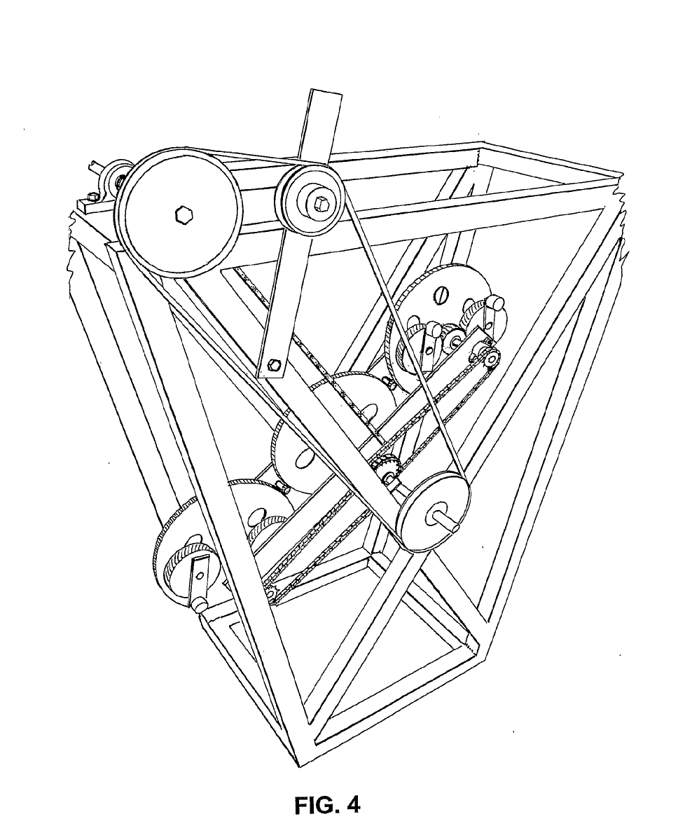

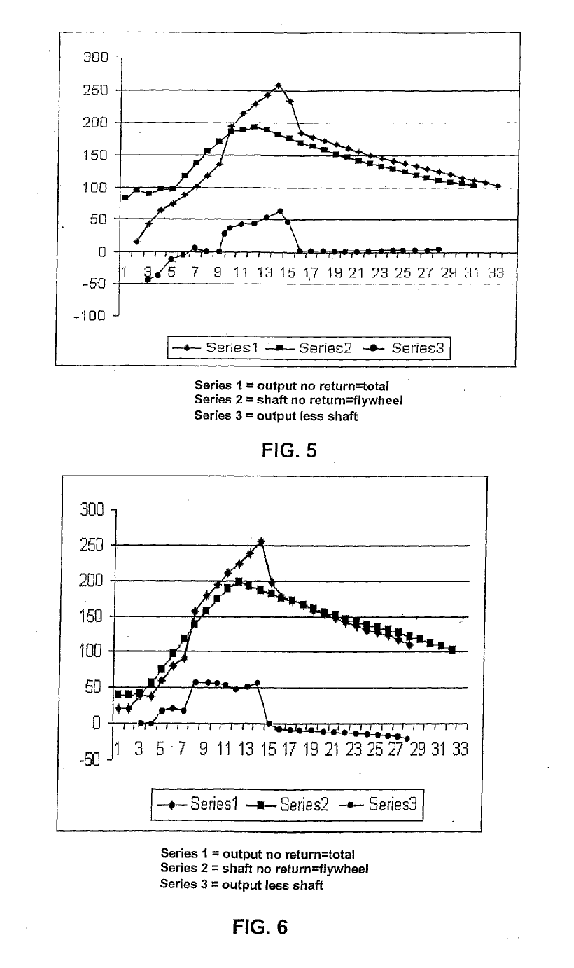

With the apparatus powered by a 650 W electric drill various charts were formulated using Microsoft Office Excel 2003 as illustrated in the charts of FIGS. 5 to 15 which in each case show variations in output RPM (vertical axis) over time (horizontal axis). Each chart formulation process was duplicated to confirm the reliability. It was shown by the above testing that:

1. The second force i.e. produced by cranking centrifugal force has been applied.

2. The output force from apparatus is not stored kinetic energy from the flywheel effect.

3. More output is delivered than input is applied.

FIGS. 5 and 6 show the charting of separate forces with the input only powered by the electric drill with respective charted lines showing total output, the output due to the first force and the output due to the second force. The rpm of the output shaft was recorded while input force was applied, with peak rpm of 255.7 & 257.9 at which point input force was withdrawn. The chart then show a sudden two refresh interval drop of rpm to 177.7 & 184.5.

When this is compared with the charts of the rpm of the radial arms 16 and 17 (being the rate of revolution of the frame gears 24 mounted to the arms 16 and 17) which show a peak rpm of 193.3 & 197.5, a difference in peak rpm between the radial arms and the output is revealed, 255.7 less 193.3=62.4 and 257.9 less 197.5=60.4 which can only be explained by the addition of rpm from the second force, due to the centrifugal force applying on the weights 33 as they are advanced by the input and amplified by the gearing differential between the frame gear 24 and output gear 20.

Once the drill's input was withdrawn, and in the absence of a return of the output power to the input shaft, and thus no drive to the input shaft to create the second force, the sudden two refresh interval drop of rpm to 177.7 & 184.5 is in response to the only remaining force left, the kinetic flywheel energy, which then gives the steady reduction in rpm as seen in all four charts of no return, tapering down to the 100 rpm rate. Below 100 rpm the centrifugal lock of the frame gears can give way causing the frame gears to spin and so no longer drive the output gear with the flywheel effect.

The additional energy supplied by the weights under centrifugal force responsible for the increase in rpm of 255.7 minus 193.3=62.4 rpm or 32.3% (see FIGS. 5 and 6) and 257.9 minus 197.5=60.4 rpm or 30.5% is particularly significant as it comes on top of the input force as applied to the flywheel energy, and as such requires exponentially greater energy (E=½ MV2).

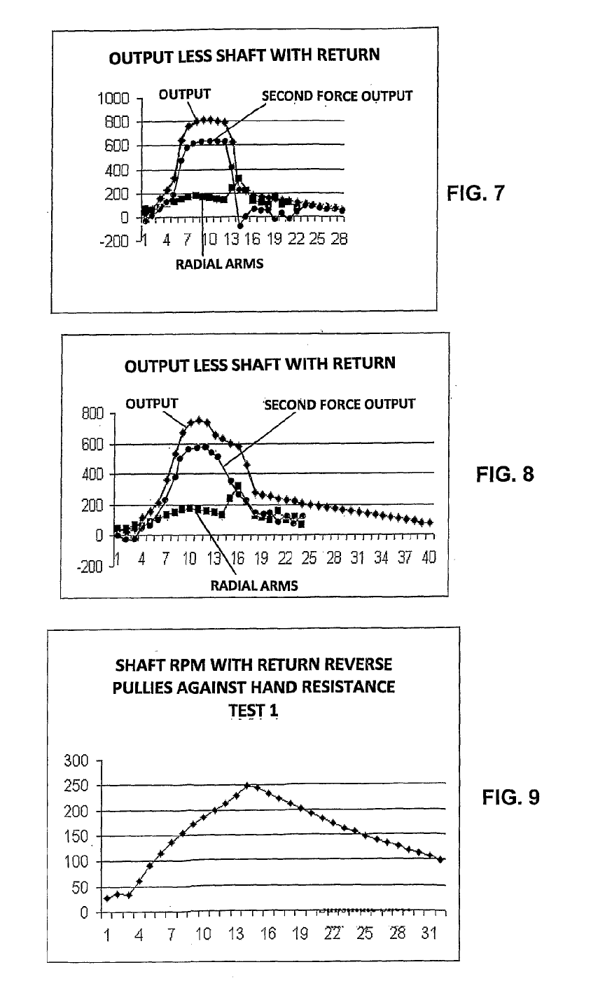

When output power was returned to the input by direct belt drive, the additional energy supplied by the weights 33 under centrifugal force responsible for the increase in rpm of 813.6 minus 157.1=656.5 rpm or 417.8% (see FIG. 7) and 748.5 minus 165.1=583.4 rpm or 353.3% (see FIG. 8)

Further tests showed that output power does not come from the kinetic, or flywheel energy alone. This is shown in tests recording the radial arms rotation, while the output is under strong hand resistance load. Irrespective of whether power was being returned to the input or not, all tests in both configurations showed that there was no drop in rpm of the radial arms while the resistance was applied. There was however a drop in rpm of the output shaft 14 which could only be a reduction of the second force attributable to the additional energy supplied by the weights 33 under centrifugal force.

The figures from the tests of the radial arms rotation during full drill input with hand resistance applications intermittently throughout were:

Radial arms with return of power from the output shaft to the input shaft (FIG. 9): constant rise from 28.1 to 249.1 when drill was removed.

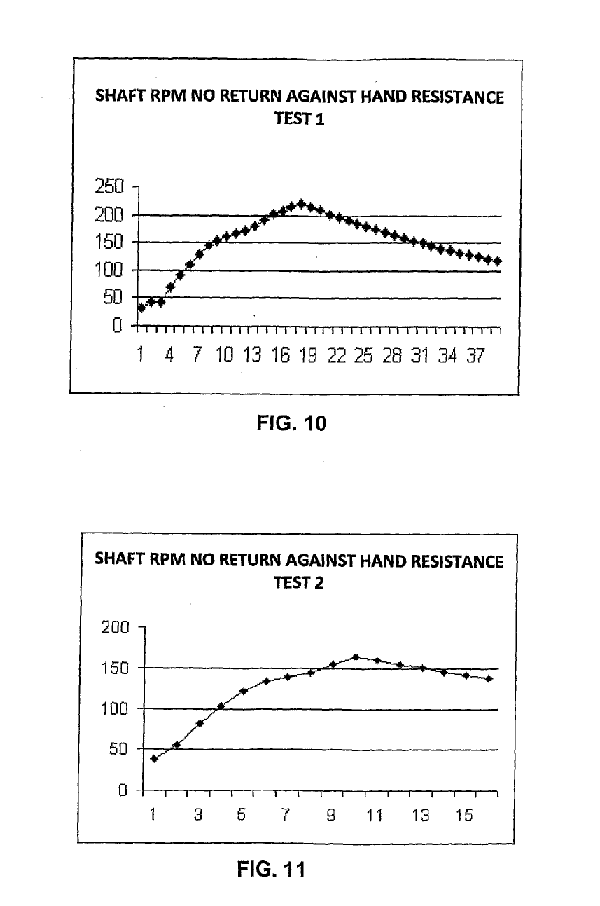

Radial arms without return of power from the output shaft to the input shaft (FIG. 10): constant rise from 32.6 to 220.4 when drill was removed.

Radial arms without return of power from the output shaft to the input shaft (FIG. 11); constant rise from 38.8 to 164.9 when drill was removed

In all cases when the drill input was withdrawn constant rpm reductions occurred.

The figures from the tests of the output shaft during full drill input with hand resistance applications intermittently throughout were:

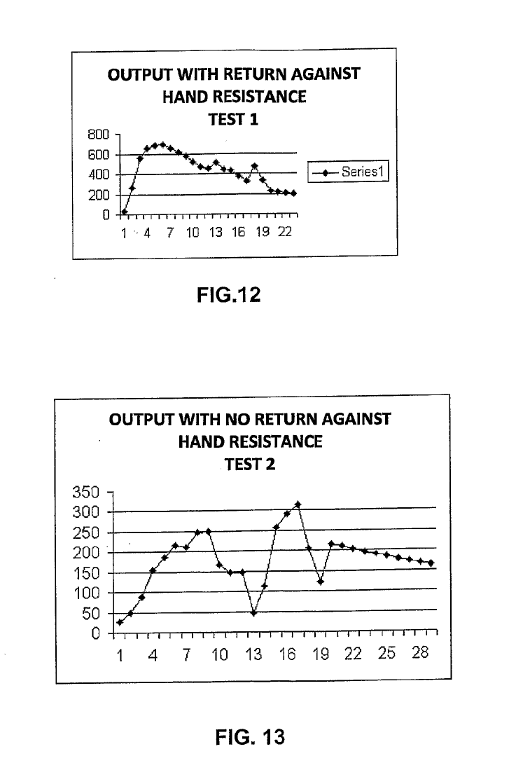

Output shaft with return of output power to the input shaft: decreases from 692.1 to 447.1 (see FIG. 12) and from 503.9 to 322.7.

Output shaft without return: decreases from 249.8 to 45.3 (see FIG. 13) and from 313.1 to 122.2

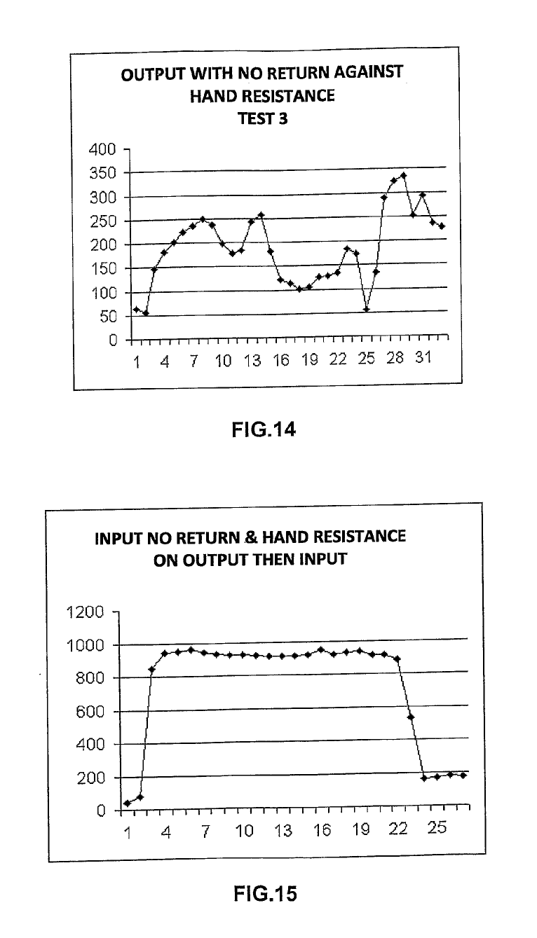

Output shaft without return: decreases from 248.5 to 178.3 (see FIG. 14) and from 258.6 to 105.7 and from 183.5 to 56.4.

FIG. 15 shows, with full power constantly applied to the drill, the rpm of the input shaft was measured without the output returned. Records show the rpm rose in one frame to 845.9 and held in the range of 845.9 to 963.1 until hand resistance was applied to the input. During this period hand resistance was applied to the output twice.

The first application was progressive commencing gently at 963.1 and increased to maximum effort at 925.3 rpm. Rpm during this progressively decreased through 963.1, 942.1, 934.2, 923.5, 925.3, 919.9, 915.7, 914.5, and 911.1 at which point hand resistance was removed and rpm rose to 948.5 when hand resistance was again applied for a short application and rpm dropped to 921.7, with hand resistance again removed rpm rose to 934.6, 915.7 and 911.2 at which time the same level of hand resistance was applied to the input shaft (with full power still applied from the drill) which slowed to 883.6, 533.6 & 162.4 at which point the drill's power was removed and rpm recorded were 162.4, 166.1, 176.2, and 170.9

In summary, FIGS. 6 and 7 show there is an additional force driving the output.

FIGS. 7 and 8 show additional force when output is returned.

FIGS. 9-14 show kinetic flywheel force is not being drained under hand load.

FIG. 15 shows the output is a far greater force than that supplied from the drill.

Therefore since the additional force at the output does not come from the kinetic flywheel and it exceeds the power of the drill, and is compounded when output is returned to the input, it must come from the centrifugal force applying on the weights, this is the second force referred to above.

In the tests the prototype apparatus having only weights 33 of less than one pound and the radial arms only run to less than 250 rpm without return of power, centrifugal force delivered to each weight is only 11.57 kg under the formula MRN2/2933. As a prospective, if a purpose machined built apparatus were to run at 7,000 rpm with only the same weights, it would generate a centrifugal force of 7,666 kg.

The principles of the apparatus apply to any different configurations of apparatus but may give a different balance of contributions from the first and second output forces, since any variation in the balance in total frame gear mass and the mass of the weights will change the dynamics of each, because the energy to supply to or extract from both a flywheel and centrifugal force varies with mass, as well as this both of these also vary with radius.

An example of net output force resultant from the second force with the test apparatus excluding friction is;

With two frame gears 24 of 7 inch radius each with weights being ½ pound and radius of weights around output of 16 inches and frame gears 24 rotating at 195 rpm and weight gears 31 centered 4½ inches out from the center of the frame gears 24, the calculations are:

½×16/12×1952/2933=8.64 lbs

8.64×3/12÷7/12=3.7 ft lbs at idler gear

3.7×4 weights=14.8 ft lbs

2×22/7×7/12=3.66 ft travel of frame gear teeth per spin

3.66×average rpm of frame gear spin at 75=275 ft per min

14.8×275=4075 ft lbs per min

1 HP=33,000 ft lbs per min

Therefore, the test apparatus without return power would he expected to deliver 12347 HP or approximately 1/8 HP

The same calculations applied to the test apparatus at different frame gear rotation rates compute to:

195 rpm yields 1/8 HPGiven that these figures are based Therefore HP

390 rpm yields ½ HPon 1:2.6 ratio of frame gear spin could be

1560 rpm yields 8 HPto shaft rpm. Comparison of charts 18.9 HP

6240 rpm yields 128 HP1&2 imply upto 1:1.1 at higher reves 320 HP

If a test apparatus had 4 frame gears 24 with weight gears 31 7 inches out and weights 33 weighing 2 lbs still housed in the housing frame of 120 cm×120 cm×55 cm such a single unit run at 195 rpm would work out to 1.97 HP and if this was run at 5,000 rpm the output would be 1,296 HP

After adjustment for correction for a 1:1.1 ratio the output would be:

run at 195 rpm would work out to 4.66 HP and if this was run at 5,000 rpm the output would be 3064 HP.

Further multiple apparatus on the common output shaft would multiply the output. The test frame housing could have room for at least three or more mechanisms.

The input RPM rate can be adjusted via the return system.

The above is limited by structural strength and draw off of energy not exceeding one half of the total output energy, based on the calculation method above. This is because exceeding this will cause the weight gears 31 to rotate away from the line of centrifugal force beyond 900 and so diminish the leverage for the second force.

The drawings herein do not display definitive specifications as they are for explanatory and demonstration purposes only. The non-inclusion of idler gears or locating them at a different point may change the mechanics of the operation but not the principle of converting centrifugal force into a useable energy resource.

Dimensions, RPM, direction of rotation, gearing and weights of components may be varied for the efficiency and output of any unit.

All moving parts should be enclosed by protective casing to prevent injury or damage that would be caused by any intrusion into the machinery or the escape of any parts which could be at high velocity under circumstances of mechanical failure however caused.

All bearings and abrading or frictional surfaces must be kept appropriately lubricated, with any spillage or recycling able to be effected by a dual function of the protective casing.

It is important that the apparatus should have at least a speed reducing system, if not a brake in between the output and the input return, so as to prevent uncontrolled power. If desired a sensor can be fitted to reduce to RPM of the drive gears if the weighted segment gets to 90 degrees to the drive gear (that is the tangent) so as to prevent stalling by over revving.

Whilst the embodiment of the invention has been described in relation to use of offset weights 33 on rotating weight gears 31 for rotation of the center of gravity of the frame gear assembly 23 around the center of the frame gears 24, alternative or additional means may be used for this purpose. For example the frame gear's 24 center of gravity could be made to rotate under centrifugal force in response to the addition of mass by the flow of a fluid through one after another of a series of ducts which radiate out around the frame gear 24 from a circular gate or manifold at the center of the frame gear 24 so as to connect the flow of a liquid to one strategically aligned duct after another. The connection could be made when a radial duct is just approaching the lead rotational direction of the frame gear 24, and this duct's connection closed (as the next is connected) and then vented by vents on the circular gate or manifold before that duct reaches the trailing direction of the frame sear so as to allow discharge of the fluid.

The circular gate or manifold could be connected via a pipe line system incorporated in the frame gear shaft 26 from one or both radial arms 16 and 17 from the Output shaft 14 with this connected to a fluid supply or sump.

Such a fluid supply could be recycled within or come from a raised supply as in a hydroelectric power station, where the system could be used in place of or in line with a turbine.

The terms “comprising” or “comprises” as used throughout the specification and claims are taken to specify the presence of the stated features, integers and components referred to but not preclude the presence or addition of one or more other feature/s, integer/s, components or group thereof.

Whilst the above has been given by way of illustrative embodiment of the invention, all such variations and modifications thereto as would be apparent to persons skilled in the art are deemed to fall within the broad scope and ambit of the invention as defined in the appended claims.

1-21. (canceled)

22. A force or energy amplifying apparatus comprising:
at least one gear assembly having an axis of rotation, said gear assembly being mounted for orbital movement around an orbit axis,
means for causing said gear assembly to orbit around said orbit axis in response to a rotational input;
means for causing rotation of said gear assembly about its axis of rotation during said orbital movement of said gear assembly as a consequence of centrifugal force;
and means for extracting energy from said orbiting and rotating gear assembly.

23. Apparatus as claimed in claim 22 wherein part of the energy extracted from the orbiting and rotating gear assembly is returned to provide said rotational input.

24. A force or energy amplifying apparatus comprising:
an input shaft;
an output shaft defining an orbit axis;
an output gear fixed for rotation with said output shaft;
at least one frame gear assembly having an axis of rotation, said frame gear assembly being mounted for orbital movement around said output gear in response to an input from said input shaft;
means for positioning and maintaining the effective center of mass of said frame gear assembly at a position or positions off-center relative to the center of said frame gear whereby to cause rotation of said frame gear assembly about its axis of rotation during said orbital movement of said frame gear assembly;
and means coupling said frame gear to said output gear whereby motion of said frame gear can be transmitted to said output shaft.

25. Apparatus as claimed in claim 24 and including at least one pair of frame gear assemblies, respective frame gear assemblies of said pair being arranged symmetrically on opposite radial sides of the output gear.

26. Apparatus as claimed in claim 24 wherein each said frame gear assembly comprises a frame gear and mass adjusting means carried by said frame gear for adjusting the center of mass of the frame gear assembly.

27. Apparatus as claimed in claim 24 and including a frame gear shaft for each frame gear assembly and mounted at a position spaced radially from and extending parallel to the output shaft, said frame gear assembly being supported to the frame gear shaft for free rotation there around.

28. Apparatus as claimed in claim 27 wherein said mass adjusting means comprise weight gears, said weight gears being movably mounted on the frame gear to enable adjustment of the effective center of mass of the frame gear assembly.

29. Apparatus as claimed in claim 28 wherein said weight gears comprise a pair of weight gears arranged symmetrically on opposite radial sides of the axis of rotation of the frame gear.

30. Apparatus as claimed in claim 29 wherein each weight gear is supported on the frame gear for rotation about an axis extending parallel to the axis of the rotation of the frame gear.

31. Apparatus as claimed in claim 27 wherein the center of mass of each weight gear is offset relative to its axis of rotation.

32. Apparatus as claimed in claim 31 wherein each said weight gear carries a weight offset from its axis of rotation.

33. Apparatus as claimed in claim 28 wherein said weight gears are arranged such that each weight or center of mass of each weight gear is concurrently radially outermost and wherein the weight gears on opposite sides of the output shaft are arranged symmetrically relative to each other.

34. Apparatus as claimed in claim 28 wherein said weight gears are in mesh with a common drive gear coaxial with the frame gear through which rotation can be transmitted to the weight gears from the input shaft, said drive gear being mounted to frame gear shaft for rotation therewith.

35. Apparatus as claimed in claim 34 wherein said frame gear shafts are supported by spaced radial arms mounted for rotation relative to the output shaft, the radial arms extending symmetrically on opposite radial sides of the output shaft.

36. Apparatus as claimed in claim 35 wherein said frame gear shafts are adapted to receive an input from said input shaft to rotatably drive the drive gears and cause said orbital motion of said frame gear assemblies.

37. Apparatus as claimed in 24 wherein the or each said frame gear assemblies is coupled to the output gear through idler gears.

38. Apparatus as claimed in claim 24 and including means for returning part of the output from the output shaft to said input shaft to maintain operation of said apparatus.

39. Apparatus as claimed in claim 38 wherein said returning means comprising mechanical or hydraulic transmission means.

40. A self powered force or energy generating apparatus, said apparatus comprising at least one body rotatable about an axis of rotation, said body being mounted for orbital movement around an orbit axis, means for causing said body to orbit around said orbit axis in response to a rotational input, means for causing rotation of said body about its axis of rotation during said orbital movement of said body as a consequence of centrifugal force, means for obtaining a force or energy output from said orbiting and rotating body and means for returning part of said output to said input to maintain operation of said apparatus.
